(19) United States
(12) Patent Application Publication
(10) Pub. No.: US 2015/0188999 A1
(43) Pub. Date: Jul. 2, 2015

(54) System and method to extend the capabilities of a web browser to improve the web application performance

(71) Applicant: Johnson Manuel-Devadoss, Pearland, TX (US)

(72) Inventor: Johnson Manuel-Devadoss, Pearland, TX (US)

(21) Appl. No.: 14/583,721

(22) Filed: Dec. 28, 2014

Related U.S. Application Data
(60) Provisional application No. 61/921,419, filed on Dec. 28, 2013.

(51) Int. Cl. H04L 29/08; H04L 29/06

(52) U.S. Cl. CPC H04L 67/10; H04L 67/22; H04L 67/42

(57) ABSTRACT

The present invention discloses a method and system to boost the web application performance by taking the snapshot of given web application along with web server and database configuration and deploying it into the client computing device and then modifying the actual web application URL by appending “L” in the beginning of URL scheme name and adding an entry in the computer file to map the given web application hostname to the Local host IP address. Anytime the user activates a link that uses the registered protocol (LHTTP or LHTTPS), the browser will route the action to the locally hosted web application URL and let user know that the request is served by locally hosted web server instead of the actual server. The user interactions on the locally hosted web application are tracked and updated in the actual web application server(s).

### RELATED APPLICATIONS

This application claims the benefit of U.S. Patent Application Ser. No. 61/921,419, filed on Dec. 28, 2013, the entire contents of which are hereby incorporated by reference.

### BACKGROUND OF INVENTION

1. Field of the Invention

The present invention relates to boosting the web application performance, more particularly improving the web application performance by reducing the load on the web server.

2. Description of Related Art

Many IT companies are spending a huge amount of money in increasing the hardware resources on the web server to improve their web application performance in terms of page rendering and reducing the spikes in the I/O utilization. Because websites can generate significant income for their operators, a need exists for methods to improve performance will less financial cost.

The production support team spends considerably lot of their time in investigating the root causes on the possible components, such as web server and the back-end configuration. Also, they are spending more time on improving the web application performance tactics such as Monitoring the web server performance and create benchmarks regularly, reducing the payload size, leveraging Cache techniques effectively, optimizing the network traffic, minifying the CSS and JavaScript documents to save a few bytes, combining CSS and JavaScript files to reduce Web requests, using server-side compression to reduce file sizes.

### SUMMARY OF THE INVENTION

80% of the end-user response time is spent on the web server. Most of this time is tied up in downloading all the components in the page: images, style sheets, scripts, flash, etc. Reducing the number of components in turn reduces the number of Web requests required to render the page. This is the key to downloading the pages faster.

The present invention describes the method and system to boost the web application performance by reducing the load on the web server. Client computing device consists of web browser plug-in component and service application that operates in the background. Similarly, application server component is a computer program that operates in the background. The operation of present invention is triggered when user types the URL in the address bar on the web browser. The web browser plug-in of the client computing device may be initiated for the web application URL. The web browser plug-in looks for the catalog settings for the given web application URL in client computing device and shared storage location that user subscribed with. If web browser plug-in component could not find the catalog settings, it may contact the application server for the web application catalog information. The application server receives the incoming catalog request from the client computing device and creates the web application catalog package which consists of web application resources and data files for the web application. This catalog package is being sent to the client computing device.

The service application of the client computing device receives the catalog package and installs & configures the web application resources to the fully managed local web server that can hosts the given web application resources. The web application specific web server will be selected from the client component web servers' collection. Similarly, the data files are being configured to the local data store and web application specific database settings are selected from the client component data files store collection. The local web server serves the user interaction requests and saves the user interactions with web application in the local data files. On a periodical basis, the service application of the client component will sync the user interaction data with application server and user's shared storage space.

The object of the present invention is to boost the web application performance by reducing the load on the web server.

Another object of the present invention is to minimize the Web requests to render the web application pages faster.

Still another object of the present invention is to optimize network traffic by ensuring that web application uses the bandwidth as efficiently as possible by optimizing the interactions between the web browser and the application server.

These together with other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1A is a diagram of an exemplary network in which systems and methods consistent with the principles of the invention may be implemented;

FIG. 1B is a diagram of an exemplary functional block diagram of web browser plug-in in which systems and methods consistent with the principles of the invention may be implemented;

FIG. 2 is an exemplary diagram of a client and/or server of FIG. 1 according to an implementation consistent with the principles of the invention;

FIG. 3A-3B are the exemplary functional block diagrams of the present invention of FIG. 1 according to an implementation consistent with the principles of the invention,

FIG. 3A is an exemplary functional block diagram of server component in accordance to the principles of present invention,

FIG. 3B is an exemplary functional block diagram of client component in accordance to the principles of the present invention.

FIG. 4A is a flowchart of exemplary processing steps for improving the web application performance according to an implementation consistent with the principles of the present invention.

FIG. 4B is a flowchart of exemplary operational sequences of client component in accordance to the present invention.

FIG. 4C is a flowchart of exemplary operational sequences of server component in accordance to the present invention.

FIG. 5 is an example of exemplary operational sequences in a manner consistent with the present invention.

### DETAILED DESCRIPTION OF THE INVENTION

The following detailed description of implementations consistent with the principles of the invention along with accompanying drawings indicated above. The same reference numbers in different drawings may identify the same or similar elements. In addition, the following detailed description does not limit the invention.

Implementation consistent with the principles of the invention is directed to boosting the web application performance. For example, implementations described herein may reduce the Web requests between web server and client computing device to boost the web application rendering performance by taking the snapshot of the all web application resources and configuring them in to the client computing device.

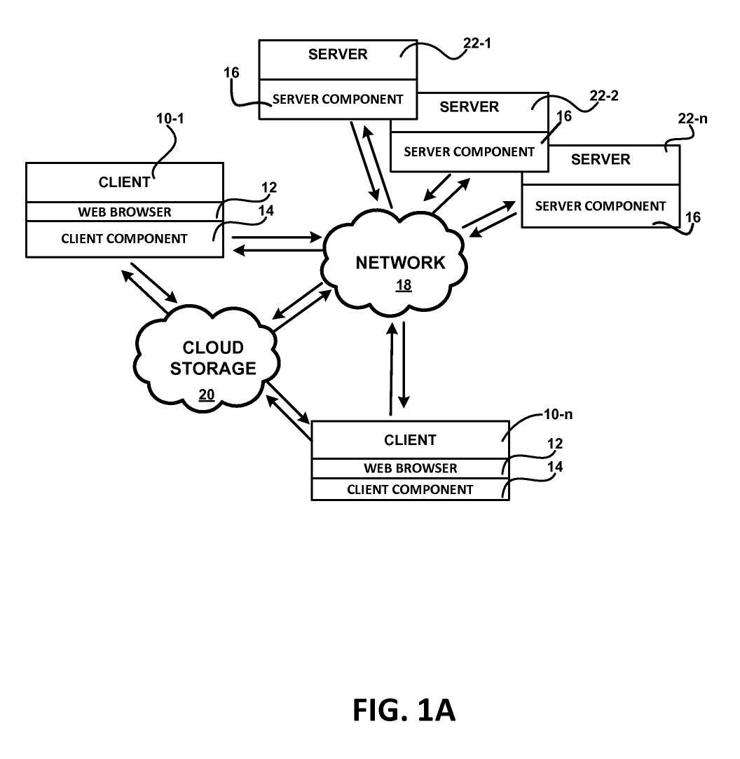

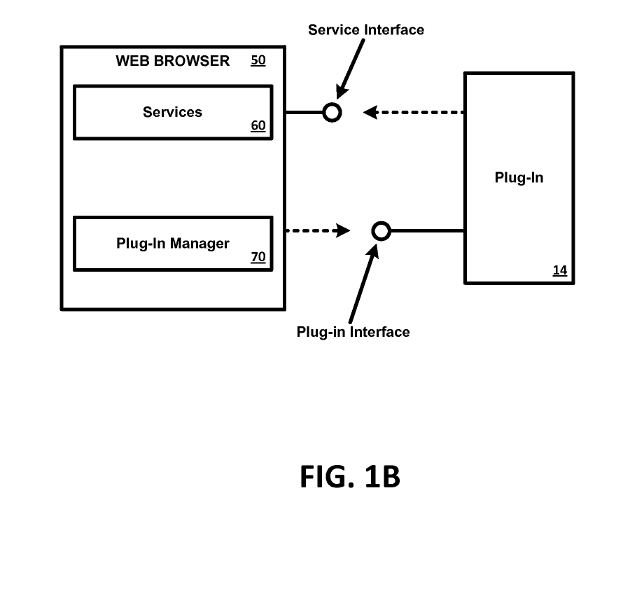

FIG. 1A is an exemplary diagram of a network 18 in which systems and methods consistent with the principles of the invention may be implemented. Network 18 may include multiple clients 10-1 . . . 10-N connected to server 22-1, . . . 22-N via a network 18. N clients 10, N servers 22 illustrated as connected to network 18 for simplicity. In practice, there may be more or fewer clients and servers. Also, in some instances, a client may perform a function of a server and a server may perform a function of a client.

Clients 10 may include client computing entities that contact the application server for requesting a catalog package for the web application URL, configuring the web application to the client computing device 10 web server and data store, updating the user interaction for the web application with application server and shared storage in a manner consistent with the principles of the invention. An entity may be defined as a device, such as a personal computer, a wireless telephone, a personal digital assistant (PDA), a laptop, or another type of computation or communication device, a thread or process running on one of these devices, and/or an object executable by one of these devices.

Servers 22 may include server entities that handle Catalog request, Catalog package creation, updating catalog package from the client computing device 10 in a manner consistent with the principles of the invention. In an implementation consistent with the principles of the invention, Client 10-1 . . . 10-N may include a client component 14 to request the catalog package from application server for the web application URL and configure the received catalog package from the web server to the local web server. The local web server configuration will be matched with whatever the actual web server configurations for the web application. For example, a web application called “portal.corp.com” is configured with apache web server, PHP, and MySQL. The client component requests the catalog package which is nothing but a snapshot of Apache web server, PHP files, and MySQL data files (schema) to configure them into a client computing device 10. The client component chooses the Apache Web Server from the Interoperable Local Web Server Collection that is applicable for the client computing device 10 operating system. Similarly, it chooses the MySQL database from data store repository to configure the web application locally.

Server 22-1 . . . 22-N may include a server component 16 to perform the server entities that handle Catalog request, Catalog package creation, updating catalog package from the client computing device 10 in a manner consistent with the principles of the invention. The server component 16 may be any combination of software agents and/or hardware modules for establishing a relationship between client computing device 10 to improve the web application performance by hosting the web application into the client computing devices 10-1 . . . 10-N. The Server 22-1 . . . 22-N may facilitate interaction and communication among client computing devices 10-1 . . . 10-N via the network 18. In one embodiment, the server 22-1 . . . 22-N may facilitate sharing the catalog package to the client computing devices 10-1 . . . 10-N. The functionality of improving the web application performance by establishing the web application host on the client computing device 10 may also be distributed across multiple client computing device disposed across the network 18.

Network 18 may include a local area network (LAN), a wide area network (WAN), a telephone network, such as the Public Switched Telephone Network (PSTN), an intranet, the Internet, or a combination of networks. Clients 10 and Servers 22 may connect to network 18 via wired, wireless, and/or optical connections.

As shown in the FIG. 1B, the web browser 50 provides services 60 which the plug-in 14 can use, including a way for plug-in 14 to register themselves with the web browser and a protocol for the exchange of data with plug-in 14. Plug-in 14 depend on the services 60 provided by the web browser 50. Conversely, the web browser 50 operates independently of the plug-in 14, making it possible for end-users to add and update plug-in 14 dynamically without needing to make changes to the web browser. Open application programming interfaces (APIs) provide a standard interface, allows creating plug-in 14 that interact with the web browser 50.

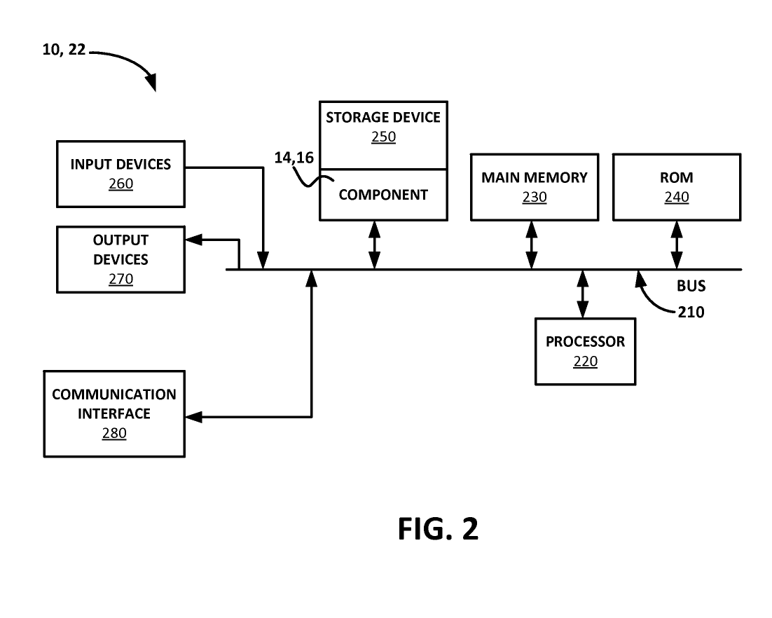

FIG. 2 is an exemplary diagram of a client or server entity (hereinafter called “client/server entity”), which may correspond to one or more of clients 10 and servers 22, according to an implementation consistent with the principles of the invention. The client/server entity may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of the client/server entity.

Processor 220 may include one or more conventional processors or microprocessors that interpret and execute instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device(s) 260 may include one or more conventional mechanisms that permit an operator to input information to the client/server entity, such as a keyboard, a mouse, a pen, voice recognition and/or biometric mechanisms, etc. Output device(s) 270 may include one or more conventional mechanisms that output information to the operator, including a display, a printer, a speaker, etc. Communication interface 280 may include any transceiver-like mechanism that enables the client/server entity to communicate with other devices and/or systems. For example, communication interface 280 may include mechanisms for communicating with another device or system via a network, such as network 18.

As it will be described in detail below, the client/server entity, consistent with the principles of the invention, boosting the web application by hosting the web application to the client computing device 10. The client/server entity may perform these operations in response to processor 220 executing software instructions contained in a computer-readable medium, such as memory 230. A computer-readable medium may be defined as one or more physical or logical memory devices and/or carrier waves.

The software instructions may be read into memory 230 from another computer-readable medium, such as data storage device 250, or from another device via communication interface 280. The software instructions contained in storage device 250 and/or main memory 230 may cause processor 220 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

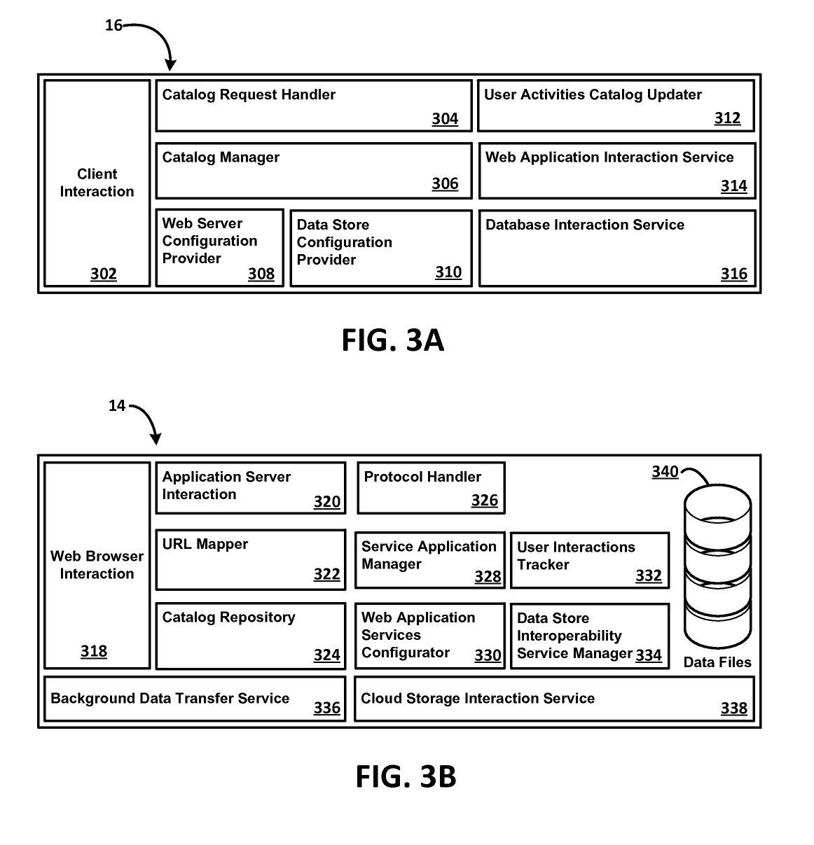

FIG. 3A is an exemplary functional block diagram for the server component 16 according to an implementation consistent with the principles of the invention. Server Component 16 includes Client Interaction 302, Catalog Request Handler 304, Catalog Manager 306, Web Server Configuration Provider 308, Data Store Configuration Provider 310, User Activities catalog Updater 312, Web Application Interaction Service 314, and Database Interaction Service 316.

The Client interaction 302 module establishes the communication or relationship path between server component 16 and client component 14. The client component 14 may uses the network protocol to communicate with the client interaction 302 module.

The Catalog Request Handler 304 is closely coupled with the catalog manager 306 module. The major operation of this module is to receive the catalog request from the client interaction 302 module and validate the request about the web application and determines the web server and database server components for the web application. For example, the catalog request handler 304 receives the catalog request for a web application URL (i.e., http://portal.corp.com) then it checks with the catalog manager about the web server and database server belonging to the portal.corp.com. Using Catalog Manager 306 module, it checks whether the web server or database server has the objects for the portal.corp.com web application URL. If the objects do not exist in the servers then it would return a 404—file not found—HTTP Code to the client component.

The Catalog manager 306 module is responsible for preparing the catalog package for the incoming catalog request for the web application URL. The Catalog manager 306 module prepares the catalog package for the requested web application URL by taking the snapshot of the requested web application URL, configuration and required setup files to host the web application and sends it the client computing device.

Web Server Configuration provider 308 is closely coupled with Catalog Manager 306 to provide the required configuration and setup files to install and configure the web server into the client computing device. That means it provides the pre-requisites to host the web application into the client computing device. It may provide a no-click deployment file to install and configure the web server where these files are being used to silently install the web server into client computing device without a manual interaction. Similarly, Data Store Configuration Provider 310 is closely coupled with Catalog Manager 306 to provide the required pre-requisites to load the schema of the database (that is being used on the web application) into the client computing device.

User activities catalog updater 312 module is responsible for updating the user actions against the web application from the client computing device 10. It receives the user interactions on the web application, parses them and updates them accordingly. The user interactions such as add or update or delete operation are being updated to the data files.

Web Application Interaction Service 314 module is responsible for taking the snapshot of the web application files and required objects to host the web application into the web server of client computing device.

Similarly, the Database Interaction Service 316 is responsible for taking the snapshot of the database schema of the web application and required object or permission to load the schema into the database server of the client computing device. Also, it may play an important role when updating the user interactions on the web application that is hosted in the user computing device.

FIG. 3B is an exemplary functional block diagram for the client component 14 according to an implementation consistent with the principles of the invention. Client Component 14 includes Web Browser Interaction 318, Application Server Interaction 320, URL Mapper 322, Catalog Repository 324, Protocol Handler 326, Service Application Manager 328, Web Application Services Configurator 330, User interactions tracker 332, Data Store Interoperability Service Manager 334, Background Data Transfer Service 336, Cloud Storage Interaction Service 338 modules.

Web Browser Interaction Service 318 module provides an interface to the web browser and client component 14. The client component 14 registers the LHTTP protocol with web browser using web browser interaction service 318 and protocol hander 326 modules. When actual web application is being hosted in the client computing device, the web browser interaction service 318 module validates and parses the HTTP response from the locally hosted web application. Also, it rewrites the reference or hyperlinks to the local host in the broken link web pages using URL Mapper 322 module. This way when user clicks on the hyperlinks from the web page of locally hosted web server then it would redirect the remaining Web requests to the locally hosted web server instead of sending it to the actual web server host.

URL Mapper 322 module is a rewrite engine that is located in a Client Component which modifies the actual web application URL's appearance. URL Mapper 322 is tightly integrated with web server that is hosted in the client computing device. It replaces the scheme name (commonly called protocol) of actual web application URL by appending “L” into the scheme name. For example, actual web application URL is http://portal.corp.com but URL Mapper 322 module modifies the URL into Lhttp://portal.corp.com after the actual web application is hosted in to the client computing device.

The client component 14 uses an “L” (LHTTP or LHTTPS) link when the actual web application is being hosted into the client computing device 10 and provides a convenient way to let users to know that this request is being served by locally hosted server instead of coming from actual server. When the link is activated, the browser receives the HTTP response from the local web server. For example, the client component 14 may use the registerProtocolHandler( )method to register itself with the web browser 12 as a potential handler for the given protocols such as LHTTP, LHTTPS, etc. Anytime the user activates a link that uses the registered protocol (LHTTP or LHTTPS), the browser will route the action to the locally hosted web application.

Catalog Repository 324 holds a list of catalog packages for the web applications. Each web application has a catalog package and it being retrieved by the Service Application Manager 328 module when setting up the actual web application into the client computing device.

Service Application Manager 328 module is a main module of the client component 14. This module is responsible for registering the plug-in of the client component 14 and registering LHTTP, LHTTPS protocols with Web Browser 12. It looks for the given URL catalog package from Cloud Storage location of the user using Cloud Storage Interaction Service 338 module when user activates the URL, if it could not find a catalog package for the given URL then it communicates to the server component 16 to receive the catalog package for the given URL. It leverages the Web Application Services Configurator 330 to configure the snapshot web server configuration of actual web server into the client computing device. Also, it leverages the Data Store Interoperability Service Manager 334 to load the data schema files for the user interactions. It tracks the user interactions on the locally hosted web application using User Interactions Tracker 332 module and builds the update package to send it back to the server component 16 using Background Data Transfer Server 336 module to update the current user activities/interactions on the web application.

Exemplary Processing

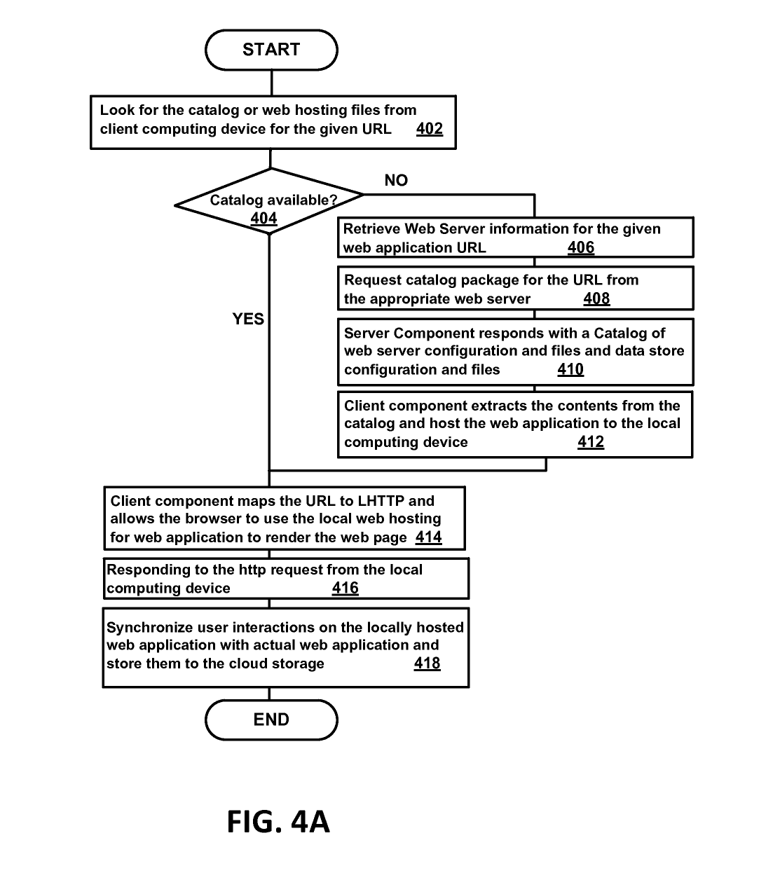

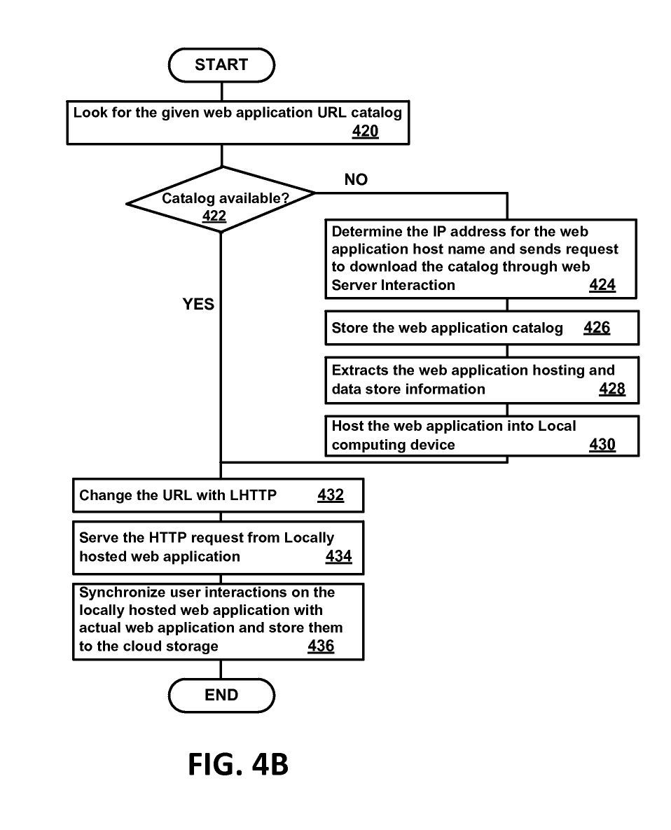

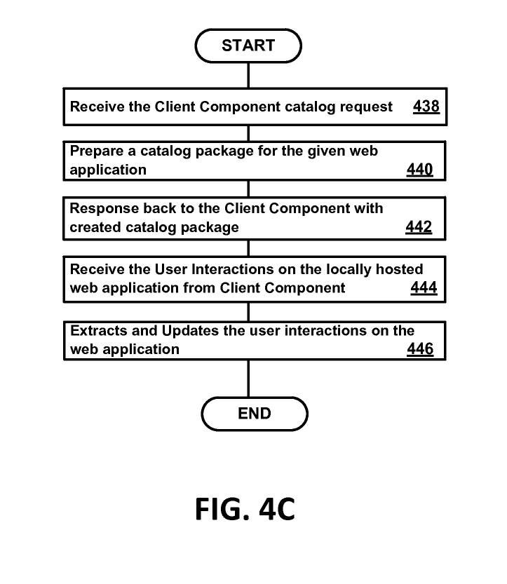

FIG. 4A illustrates the schematic view of the operation of the present invention. In Act 402, a client computing device web browser plug-in of the client component 14 in accordance to the present invention will be triggered when user has given the web application URL. The client component 14 of client computing device 10 looks for the catalog information from the client computing device 10 such as web hosting information for the given web application URL. If there is no catalog/web hosting information available in the client computing device 10 then client component 14 looks for the web hosting/catalog information from user's subscribed shared storage (i.e., Cloud Storage).

In Act 404, Client component 14 checks if there is web hosting or catalog information is available in the client computing device 10 or cloud storage for the given web application URL. If there is web hosting or catalog information for the given web application then it goes to Act 414. If there is no web hosting or catalog information available then the client component 14 retrieves the web application server information such as IP address to reach the server to request catalog for the given web application URL as shown in the Act 406.

In Act 406, the client component 14 uses the computer network administration utility to test the reachability of a web application host server on an IP network. Normally, the client component 14 sends the ICMP echo request packets to the servers of the web application and receives an ICMP response with server IP address.

In Act 408, the client component uses the retrieved IP address to send the catalog request. The client component 14 uses the background data transfer service to contact the server IP and send the catalog request and asynchronous transfer of files between machines using idle network bandwidth. Background data transfer service transfers files on behalf of client component 14 asynchronously.

In Act 410, the server component 16 receives the catalog request from the client component 14 of the client computing device 10 and prepares the catalog package that contains necessary files to host the web application to the client computing device 10. For example, if the web application uses the PHP, MySQL and Apache web server then the server component 16 prepares the necessary files to install & configure the Apache, PHP, and MySQL components along with web application related files to the client computing device 10. The server component 16 sends the prepared catalog package to the client computing device 10.

In Act 412, the client component 14 receives the catalog package from the server component 16 via background data transfer service component. The received catalog package is then extracted and installed & configured into the client computing device 10.

In Act 414, once the web application files hosted & configured locally then client component 14 converts the URL to LHTTP (LOCALHTTP) where all the HTTP calls will be redirected to LHTTP. The client component of the present invention allows the web browser to use the local web hosting files to serve the web application using web browser interaction component and URL mapper component.

As mentioned in the Act 416, the Web requests for the given web application URL served by the locally hosted web application files.

In Act 418, the user interactions on the locally hosted web application is synchronized with the actual web application by using background data transfer service. Background data transfer service creates queues and does bulk synchronizations of user interactions on the web application. The server component 16 receives these interactions of user and updates the cloud storage accordingly.

Exemplary Operation Steps of Client Component

FIG. 4B illustrates the exemplary action sequences carried out by the client component in accordance to the present invention. In Act 420, the URL Mapper module of the client component looks for the catalog information such as web hosting information from the local client device 10 for the given web application URL. If there is no catalog/web hosting information available in the local client device 10 then client component 14 looks for the web hosting/catalog information from user's subscribed shared storage (i.e., Cloud Storage).

In Act 422, Client component 14 checks if there is web hosting or catalog information is available in the client device 10 or cloud storage for the given web application URL. If there is catalog information such as web hosting for the given web application then it goes to Act 432. If there is no web hosting or catalog information available then the client component 14 uses the URL mapper module to retrieve the web server information such as IP address to reach the application sever and request catalog for the given web application URL using Web Server Interaction module as shown in the Act 424. The URL mapper module of the client component 14 uses the computer network administration utility to test the reachability of a web application host server on an IP network. Normally, the client component 14 sends the ICMP echo request packets to the servers of the web application and receives an ICMP response with server IP address.

The client component 14 uses the retrieved IP address to send the catalog request. The client component 14 uses the Background data transfer service to contact the server IP and send the catalog request and asynchronous transfer of files between machines using idle network bandwidth. Background data transfer service transfers files on behalf of client component 14 asynchronously. The downloaded catalog information for the given web application URL is being stored in the catalog repository as shown in Act 426.

In Act 428, the Service Application Manager 328 module of the client component 14 extracts the catalog information and leverages the Web application services configurator 330 and Data store interoperability service manager modules to configure the web application into the local client device.

In Act 430, the data store information is being stored into the data files through Data store interoperability service manager. Example, if catalog information holds a configuration of web application that uses a MySQL then Data store interoperability service manager leverages the MySQL database configuration to setup a MySQL database in the local client device. Similarly, if catalog information holds a configuration of web application that uses apache web server to host the web application then Service Application Manager 328 module of the client component uses the interoperable local web server to host the web application with apache configuration. Then Service Application Manager 328 module adds an entry in the computer file to map the given web application hostname to the local IP address. Generally, a computer file referred here may be a host file that is being used by an operating system to map hostnames to IP addresses.

In Act 432, the Service Application Manager 328 module of the client component leverages the Web browser interaction module 318 to change the URL with LHTTP (LOCALHTTP) to show the users that the Web request is being served by locally hosted web application in the client device as shown in Act 434. In Act 436, the client component synchronizes the user interactions on the locally hosted web application to actual web server as queued bulk operations and stores the user interactions to the cloud storage.

Exemplary Operation Steps of Server Component

FIG. 4C illustrates the list of operational sequences of the server component in accordance to the present invention. In Act 438, the catalog request handler module of the server component receives the catalog request from client component. It responds to the client component request with Catalog package for the web application.

In Act 440, the catalog package is being created by the Catalog Manager. The catalog manager of the server component takes the snapshot of web application to prepare the catalog package with required resources to host the web application. The catalog package may comprise of web server configuration settings, web application files, database files and settings. This information is being retrieved from the Web Server and Data store configuration providers.

In Act 442, the web application catalog package is sent to the client component using client interaction module of the server component. In Act 444, User interactions on the locally hosted web application from client computing device are being received to server component. The User activities catalog updater module of the server component receives and validates the package and sends it to the catalog manager module to process the user interaction updates.

In Act 446, the catalog manager module of the server component extracts the user interactions package and updates them to the server copy of data and web application files. These actions are being carried out using Web Application and Database Interaction Service modules of server component.

While series of acts in accordance to the present invention have been described with regard to FIG. 4A-C, the order of the acts may be modified in other implementations consistent with the principles of the invention. Further, non-dependent acts may be performed in parallel.

### Example

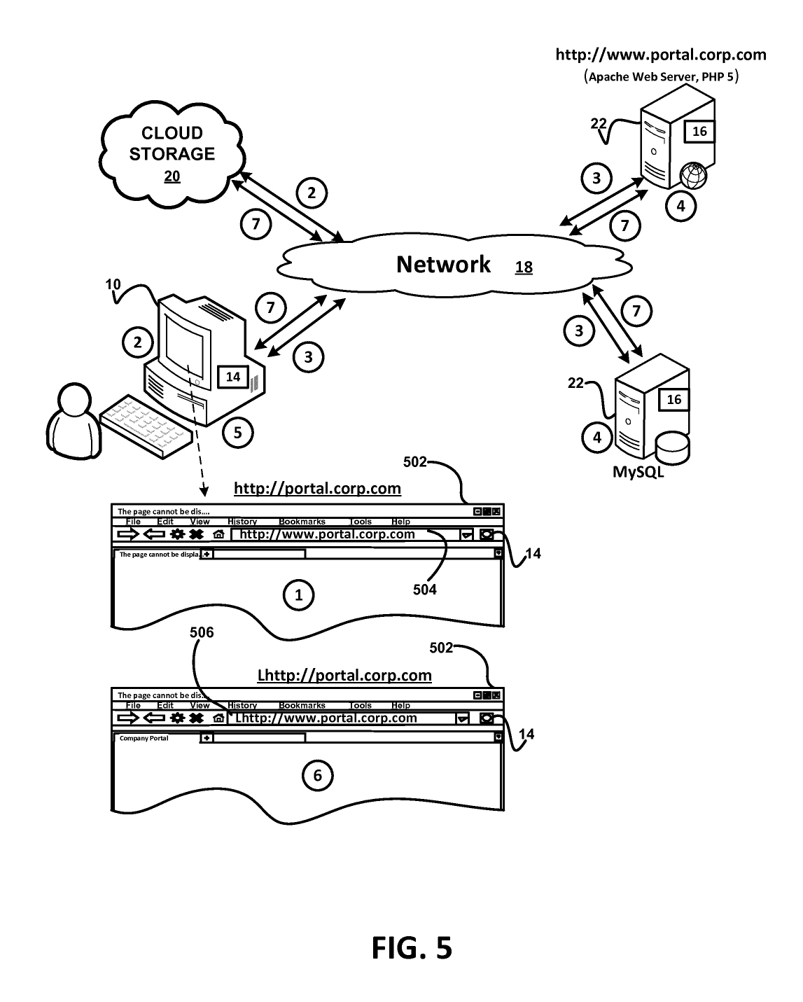

FIG. 5 illustrates the exemplary operation of the present invention. As illustrated in FIG. 5, the circled numbers represents the action sequence of present invention in accordance to improve the web application performance by hosting the web application into the client computing device 10. In action sequence 1, a client machine web browser 502 plug-in of the client component 14 in accordance to the present invention will be triggered when user has given the web application URL 504 (i.e., http://portal.corp.com).

In action sequence 2, the web browser plug-in of the client component may look for the catalog information from the interoperable local web application server collection and user's subscribed cloud storage 20. If catalog information for the given web application URL exists in the client computing device 10 as well as user's subscribed cloud storage then plug-in retrieves the http response from the local application server and renders into the web browser by changing the protocol to LOCAL HTTP (i.e., Lhttp://portal.corp.com) as illustrated in the action sequence 6. The client component 14 converts the protocol to LHTTP to differentiate the HTTP response from the actual application server 22 and the local application server in client computing device 10.

In action sequence 3, If catalog information for the given web application URL does not exists in the client computing device and in user's subscribed cloud storage then client component retrieves the IP (internet protocol) address for the given web application URL to contact the application server to get the catalog information for the web application. In action sequence 4, the server component 16 takes the snapshot of web application to prepare the catalog package with required resources to host the web application in client computing device 10 and sends it to client computing device 10.

In action sequence 5, the client component 14 receives the catalog package from the server component 16, and extracts the required resources to host the web application in the client computing device 10. The client component 14 adds an entry in the computer file to map the given web application hostname to the local IP address. Generally, a computer file referred here may be a host file that is being used by an operating system to map hostname to IP addresses. Then it changes the URL 506 to LHTTP (LOCALHTTP) to allow web browser to load the pages from local web application server as shown in the action sequence 6.

In action sequence 7, the client computing device 10 web application updates are synchronized with actual web application servers 22. In addition, the updates are stored into user's cloud storage 20 to make it as a backup.

### CONCLUSION

Implementations consistent with the principles of the invention may host the web application from actual servers to client computing device 10 to reduce the Web requests and reduce the load on the servers to improve the web application performance.

The foregoing description of implementations consistent with the principles of the invention provides illustration and description, but is not intended to be exhaustive or to limit the invention to the precise form disclosed. Modifications and variations are possible in light of the above teachings or may be acquired from practice of the invention.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claim is:

1. A non-transitory computer-readable storage medium storing instructions that when executed by a computer cause the computer to perform a method for extending the capabilities of a web browser to boost the web application performance, the method comprising:
creating the catalog package for the given web application URL;
deploying the actual web application into the client computing device;
rewriting the actual web application URL's by appending “L” in the beginning of URL's scheme name;
adding an entry in the computer file to map the given web application hostname to the Local host IP address;
providing http response from locally hosted web application URL when user activates a link;
tracking user interactions on the locally hosted web application;
sending the user interactions from client computing device to actual web application server;
synchronizing the current user activities/interactions on the web application.

2. The non-transitory computer-readable storage medium of claim 1, wherein
creating the catalog package is preparing the package by providing the required configuration and setup files to install and configure the web server and required pre-requisites to load the schema of the database into the client computing device.

3. A machine-readable medium embodying instructions that may be performed by one or more processors, the instructions comprising:
instructions for establishing the communication path between server component and client component;
instructions for receiving and validating the request for snapshot of the web application;
instructions for creating the catalog package for the given web application URL;
instructions for providing the required configuration and setup files to install and configure the web server into the client computing device;
instructions for providing the required pre-requisites to load the schema of the database (that is being used on the web application) into the client computing device;
instructions for registering the LHTTP protocol with web browser;
instructions for rewriting the actual web application URL's by appending “L” in the beginning of URL's scheme name;
instructions for adding an entry in the computer file to map the given web application hostname to the Local host IP address;
instructions for configuring the snapshot web server configuration of application web server into the client computing device;
instructions for tracking the user interactions on the locally hosted web application;
instructions for synchronizing the current user activities/interactions on the web application.

4. The machine-readable medium of claim 3, wherein
creating catalog package is preparing the required objects to host the web application into the client computing device.

5. A system comprising:
one or more processors; and
a computer-readable storage device storing instructions that, when executed by the one or more processors, cause the one or more processors to perform the operation of improving the rendering performance for a given web application in client computing device, the operation comprising:
creating the catalog package for the given web application URL;
deploying actual web application to client computing device;
registering the LHTTP protocol with web browser;
rewriting the actual web application URL's appearance by appending “L” in the beginning of URL's scheme name;
adding an entry in the computer file to map the given web application hostname to the Local host IP address;
configuring the snapshot web server configuration of application web server into the client computing device;
tracking the user interactions on the locally hosted web application;
synchronizing the current user activities/interactions on the web application.

6. The system of claim, wherein
Creating the catalog package is preparing the package by providing the required configuration and setup files to install and configure the web server and required pre-requisites to load the schema of the database into the client computing device.
